(19) United States
(12) Patent Application Publication
(10) Pub. No.: US 2026/0094501 A1
(43) Pub. Date: Apr. 2, 2026

(54) Prize Dispensing Process in Game of Chance

(71) Applicants: Stanislav Konrath, Milwaukee, WI (US); Christopher Trudeau, Milwaukee, WI (US); Robert Deiss, Milwaukee, WI (US)

(72) Inventors: Stanislav Konrath, Milwaukee, WI (US); Christopher Trudeau, Milwaukee, WI (US); Robert Deiss, Milwaukee, WI (US)

(21) Appl. No.: 19/411,607

(22) Filed: Dec. 8, 2025

Related U.S. Application Data
(62) Division of application No. 19/070,014, filed on Mar. 4, 2025, now abandoned.
(60) Provisional application No. 63/561,482, filed on Mar. 5, 2024.

(51) Int. Cl. G07F 17/32; B65B 61/02; G06K 19/06; G06Q 30/018; G07F 17/42

(52) U.S. Cl. CPC G07F 17/3255; B65B 61/025; G06Q 30/0185; G07F 17/3237; G07F 17/3241; G07F 17/3246; G07F 17/3253; G07F 17/42; G06K 19/06037

(57) ABSTRACT

In-pack chance promotional games, systems and methods utilize playing tickets that include computer readable portions such as QR codes. The QR code allows for players to redeem any instant win game pieces conveniently directly at an automatic pay station or redemption terminal or at a pull-tab vending machine thereby avoiding human error with on-site staff having to process the winning game pieces. Larger reward points amounts can correlate to larger instant win prizes further encouraging players to self-report. After determining the prize is above a certain value, entry of the prize winner's personal information may be required, and the information directed to a governmental agency or entering it into a database for future reference. The prize is dispensed in the form of cash from the automatic pay station directly to the prize winner.

### CROSS REFERENCES TO RELATED APPLICATIONS

This application is a divisional application of U.S. application Ser. No. 19/070,014, filed Mar. 4, 2025, which claims the benefit of priority of U.S. Provisional App. No. 63/561,482, filed Mar. 5, 2024, the disclosures of both of which applications are incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to In-Pack Chance Promotions in general and to playing pieces and systems for tracking and awarding prizes for such promotions in particular.

Gaming activities with awarded prizes are regulated by most states. In-pack chance promotions are promotional games, wherein a player receives a playing card or playing ticket (game piece) that gives the player an opportunity to win an instant prize. The In-Pack Chance Promotion differs from a lottery by the game piece itself having a value component, either through a coupon on the game piece for other goods or through inherently having value such as being a collectible item. In-pack chance promotions further differ from a lottery game where there is a defined winner and a defined loser. The instant win portion of the game serves as a promotional incentive to encourage purchasing or obtaining of the game pieces. Although game pieces are usually purchased, regulations require that a game piece must be provided at no charge to those who request one, for example by writing in to the promoter and requesting a game piece. Finally, the In-Pack Chance Promotion has a defined end-date, clearly states the odds of winning, and generally the game promoter is required to keep track of personal information of winners of prizes over a certain amount.

One of the more common types of in-pack chance promotion is the pull-tab ticket or card. The pull-tabs are generally made of heavy paper or cardboard, and have one or more rows of symbols that are covered by a tab having a perforated perimeter. The pull-tabs are generally sold in boxes or “packs” of several thousand tickets to locations that desire to run the promotion and sell the tickets. Players receive a ticket, either purchased at the participating location directly from staff or from a vending machine, or by writing in to the promoter. The player pulls back the covering tab to reveal the markings which indicate whether a prize has been won. If the symbols reveal a certain winning pattern, as defined elsewhere on the ticket, the player can redeem a prize, usually a cash amount. This redemption of the instant win prize is currently handled by staff on-site at locations where the game pieces are sold. The winning player may then choose how to realize the value component aspect of the ticket, possibly by saving it as a collectible, or using the coupon on it to save money on the goods that are offered.

Generally, the instant win component of prior art in-pack chance promotional games is enjoyed by players, but the value component is underutilized. Most game pieces are thrown away, instead of being collected (if collectable), or redeemed (if a coupon).

Another issue with current in-pack chance promotions is the lack of compliance with various government rules and regulations that require the promoter to maintain a list of instant win prizes awarded above a certain value, as well as personal information of the winner. Current methods of reporting of such prizes, for example, any prize of $100 or more, require the staff at a participating location to write down the required information from the player who won. This results in a less than desirable compliance rate, putting the ticket promoter at risk in certain locales. Ticket promoters may be forced to limit the value of the instant win prizes, thereby decreasing the efficacy of their promotion.

On-site redemption of the instant win part of the ticket by staff requires that cash must be kept on-site, introducing security risks and opportunities for employee theft. It also occasions frequent inefficiency, where a customer purchases a ticket, instantly wins a prize of $1, and wants to cash it in to buy another ticket. This is a frequent annoyance for staff, who are generally busy doing other things, a common example being a bartender. There is also potential for fraud with the current system wherein a player can cash in a ticket with staff that was not sold on premises, has been modified to show a higher Instant win value, or has already been paid elsewhere.

An improved system is needed to address these shortcomings.

### SUMMARY OF THE INVENTION

The present invention is directed to an in-pack chance promotional game and awards program. The invention incorporates computer readable medium into the playing tickets of the in-chance promotional games.

The in-pack chance promotional game can be in the form of a pull-tab ticket.

The promotional game of the present invention consists of three portions:
The potential instant win portion that helps entice players to obtain the game piece
The Value Component of the game piece that gives it its value, such as being collectible or having value as a coupon towards other goods
The Player Rewards portion, accessible via the obscured computer readable code. The in-pack chance promotional games of the present invention are capable of more efficient redemption of the instant win portion, an improved value component, and a player rewards program compared to the prior art.

The in-pack chance promotional games of the present invention encourages self-reporting of large game piece instant win values. The invention incorporates an obscured computer-readable medium into the game pieces of the in-pack chance promotional game, generally but not necessarily in the hidden prize data or winning combinations.

The player receives a ticket, either directly from a seller, from a vending machine, or requesting a ticket from the promoter. The player then pulls open the tab to reveal whether the underlying window reveals an instant prize. The player can then scan the revealed QR code on the ticket to redeem a prize, verify whether there is an instant prize, and to access the promotional portion of the pull-tab.

The player can scan the QR code by using a stand-alone scanner, a scanner attached to the ticket dispenser, or by using a smart phone or other smart device.

The promotional portion of the game can be accessed by logging onto a connected webpage or website, either directly onto the Internet or through a phone app.

The present invention also contemplates systems and methods of providing promotional materials through the use of pull-tabs or similar in-pack game tickets.

The present invention also provides systems and methods for complying with in-pack chance promotion rules and regulations by providing a computer readable medium within a playing ticket to track a player's necessary information.

Further objects, features and advantages of the invention will be apparent from the following detailed description when taken in conjunction with the accompanying drawings.

### BRIEF DESCRIPTION OF THE DRAWINGS

FIG. 1 is a top plan view of a pull-tab ticket game piece of the present invention prior to being played.

FIG. 2 is a perspective view of a player opening up the pull-tab ticket of FIG. 1.

FIG. 3 is a top plan view of an opened pull-tab ticket that does not have an instant winner.

FIG. 4 is a top plan view of an opened pull-tab ticket that does have an instant winner.

FIG. 5 is a perspective view of a game piece vending machine including a scanning device of the present invention.

FIG. 6 is a flow chart showing the process for obtaining, playing and redeeming the game pieces of the present invention.

FIG. 7 is a perspective view of an automatic pay station including a scanning device used in the present invention.

FIG. 8 is a rear elevational view of the game piece of FIG. 1 showing a value component involving a coupon for goods elsewhere, with other game info, text, prize info, and artwork.

FIG. 9 is a rear elevational view of an alternative game piece of this invention, having a value component in the form of a cut-out collectible pog with other game info, text, prize info, and artwork.

### DESCRIPTION OF THE PREFERRED EMBODIMENTS

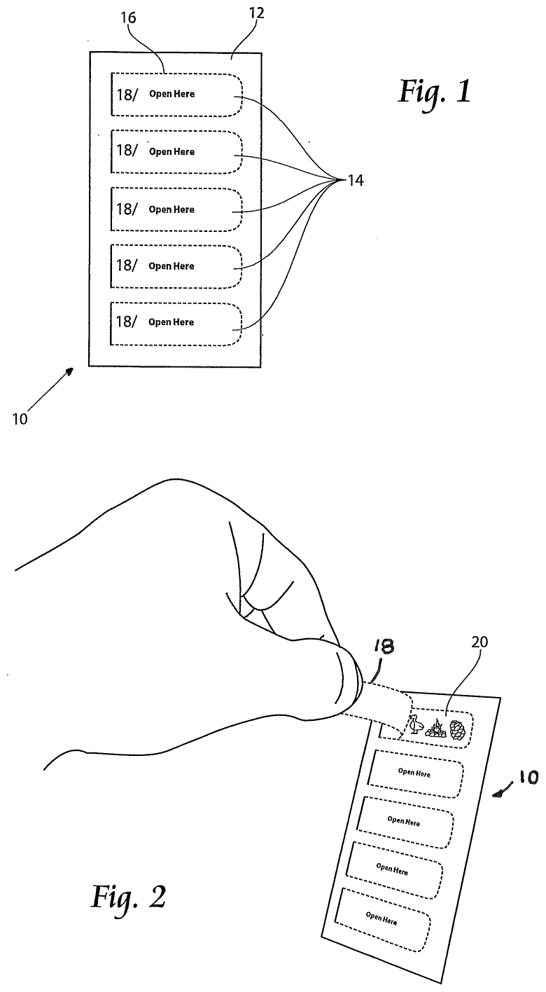

Referring more particularly to FIGS. 1-9, wherein like numbers refer to similar parts, the invention generally has four aspects:
I. Instant win game tickets used in in-pack chance promotions
II. Use of QR codes to collect player data for rewards points and prizes, and regulations compliance
III. Use of QR codes for redemption of the instant win component at automatic pay stations for cash or at pull-tab vending machines for credit
IV. Use of QR codes for improving or tracking of the redemption of the value component

### I. Instant Win Game Tickets Used in in-Pack Chance Promotions

As shown in FIGS. 1-3, a pull-tab ticket or game piece 10 for an in-pack chance promotional game has a paper or card substrate 11 with a perforated top layer 13.

The game piece 10 has a game side 12. The top layer 13 is perforated to define a plurality of tabs 18 within slots 14 with a perforated edge 16 which preferably surrounds each tab on three sides. The slots 14 are generally in a rectangular or near-rectangular shape.

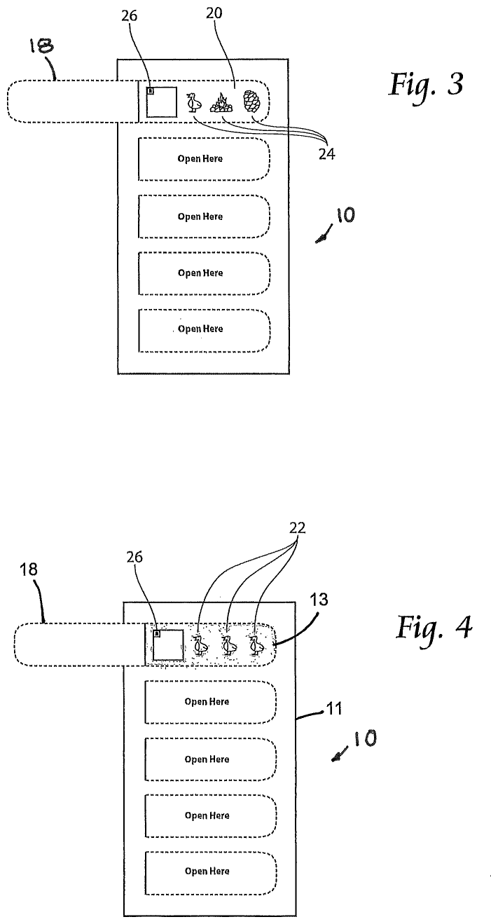

Once the pull tab ticket 10 is purchased, the player will grab the ticket 10 and pull the tab 18 along the perforated edge 16 as shown in FIG. 2. There may be one or more tabs 18 on the ticket 10. Once the tab 18 is pulled back, a window 20 is revealed underneath each of the tabs 18, showing an instant winning combination 22 (FIG. 4) or a losing combination 24 (FIG. 3). A typical winning combination may occur when all of the symbols in a window are the same symbol; however, there may be winning combinations that extend over more than one window, such as a winning symbol required in each window in a diagonal pattern. The associated prize may then be redeemed.

The purpose of the tab 18 is to obscure the window 20 until the game ticket is acquired by an individual and the window is revealed. The game piece may be provided with various types of surface obscurement that will hide the underlying window 20 from the player until the surface obscurement is removed. Other types of surface obscurements include include scratch-off materials, e.g. foil or ultraviolet (UV) ink, used on game cards, or a beverage bottle that would prevent a person from viewing a prize located on the inside of a bottle cap.

As shown in FIGS. 2 and 3, one of the windows 20 on the ticket 10 will include a computer readable code, e.g. a QR code (quick response code) 26, which can be used by a player to determine whether the ticket is an instant winner. If the ticket 10 has the QR Code located underneath one of the tabs 18, that ticket 10 could be considered a winning ticket. It may also be that all tickets in a particular In-Pack Chance promotional game have a QR located on the ticket 10, and the QR code will assist the player in confirming whether or not the ticket 10 was an instant winner.

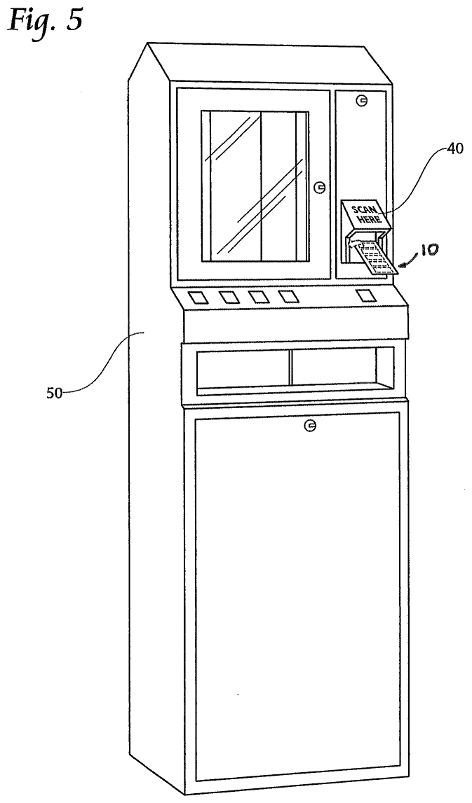

The QR code 26 encourages the user to scan it using a scanning device, such as a smartphone, tablet, computer, or other such device, once the user has determined that the ticket 10 is a winning ticket. For the Instant Win portion, the QR Code 26 could be utilized in two different ways. For example, as shown in FIG. 5, a scanning device 40 may be incorporated into a ticket dispensing machine 50. A smartphone, tablet or other computer device may also be used to scan the QR Code 26. The scanning device 40 may also be a stand-alone machine, such as an automatic pay station 55 (see FIG. 7).

Once the QR code 26 is scanned, the winner's information can be entered into a database for future reference. When the QR code is scanned through a smart device, a prompt will be given to either (1) set-up an account or (2) sign into an account. Once account verification is confirmed, the player can proceed to redeem the Rewards Point associated with the ticket to add them to their account to be used for grand prize drawing entries, merchandise, or other rewards.

At participating locations that have a pay station FIG. 7 on-site that is able to scan QR codes, the player can scan their winning ticket to dispense the Instant Win cash prize instead of being paid by staff.

Optionally, instead of collecting the Instant Winning from a winning ticket either from an Automatic Pay Station or staff, the player may opt to scan the QR code on a pull-tab machine to redeem an equal value of additional game pieces.

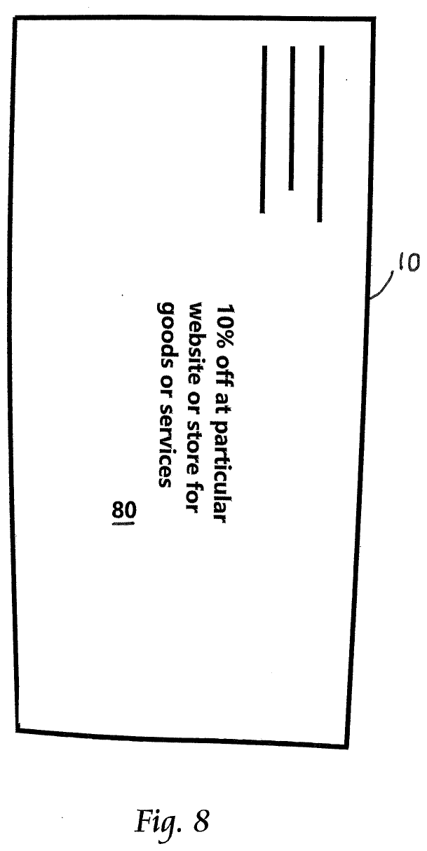

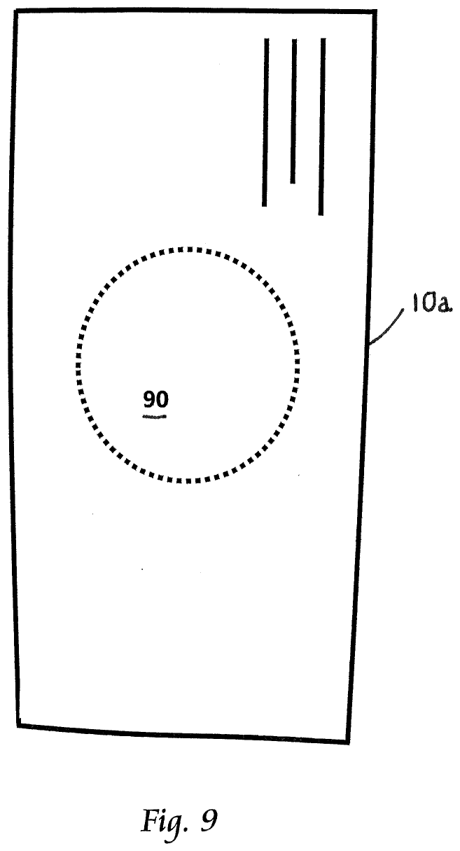

The player can then utilize the Value Component of the game piece, either by saving the collectible portion 90 (see FIG. 9), or redeeming the coupon 80 (see FIG. 8) for desired goods or services.

### II Use of QR Codes to Collect Player Data for Rewards Points and Prizes, and Regulations Compliance

As discussed above, the present invention also contemplates systems and methods for collecting player information for Player Rewards and regulation compliance. As noted above, the games generally are carried out with game pieces, such as the tickets 10, discussed above. Besides the tickets 10 having an instant winning portion, there is the Player Rewards portion of the in-pack chance games.

Referring again to FIGS. 2 and 3, the QR Code is shown in one of the windows 20 on the ticket 10. The QR Code 26 can be used on all tickets 10, both instant winners and losers or the QR Code 26 can be used only on winning tickets. For example, in the instance where the QR Code 26 is placed only on the instant winning tickets, the player would scan the QR Code to not only redeem the instant prize at an Automatic Pay Station as stated above, but also to monitor or track the Players Rewards portion associated with the promotional game of the present invention. For example, the Player Rewards portion of the invention may allow the player to accumulate points for merchandise or may give the player points toward a future drawing.

The QR Code 26 encourages the users to scan it using their device, such as a phone, tablet, or computer, to thereby record any Reward Points that they may have accumulated.

Once the QR Code 26 is scanned, the QR code 26 will be read to determine how many points have been accumulated for that player. These points may be used as entries into grand prize drawings or in exchange for merchandise or other rewards. Rewards points are correlated to cash prizes won, to further encourage the winner to scan and self-report. Further, the player's account will go up in level by accumulating more points, resulting in unique rewards at predetermined levels. All of the points may be recorded in another data storage device.

A key aspect of the present invention is the ability for the Promoter to comply with various rules and regulations. Depending on the amount won in an In-Pack Chance promotional game, and the particular state in which the player resides or plays, the Promoter may be required to report the winning amount to that state department, e.g. the state Department of Revenue (DOR). The present invention streamlines the process, by providing the game tickets 10 with the QR Code 26.

When the player wins and scans the QR Code 26, the player's information may be entered, e.g. name, address, amount won, which can then be directed towards the proper agency.

This self-reporting not only ensures that the individual players are encouraged to comply with regulations, but also assists the Promoter of the In-Pack Chance game cards to comply with various statutes and regulations. The ability to self-report also allows for larger prizes to be offered for the In-Pack Chance game. Often prizes are limited in size, as lower cash amounts are not necessarily required to be reported, e.g. prizes less than $100, depending on the state, while larger amounts are required to be reported. When the QR Code 26 is scanned, the information is recorded and the player can self-report, thereby increasing compliance with rules and regulations. The Promoter could offer larger prizes, e.g. a $10,000 promotional prize, and have confidence the prize amount is properly reported.

For the Rewards Program component of the game piece, the QR code 26 would be scanned by the player, generally via smartphone, but possibly through other scanning devices that link to the Player Rewards database via the Internet.

Assuming the player is logged in on the Player Rewards website, any rewards points on scanned game pieces will be automatically added to their account. If they are not logged in they will be prompted to log in or create an account, after which the points will be added to their account. The number of Rewards Points on a game piece could be directly correlated to the Instant Win prize amount, such as a $5 Instant Win equating to 5 Reward Points or a $500 Instant Win equating to 500 points. This schema would incentivize more frequent redemption of Rewards Points from higher Instant Win prizes, thus ensuring better compliance when keeping a list of winners over a certain amount.

The Player Rewards portion of the game can be accessed by logging into a web page, either directly on the Internet or through a phone app.

While there are many ways the Rewards Points values can be assigned to the game pieces, a correlation of larger Reward Points amounts to large Instant Win prizes will incentivize players to self-report their winnings to provide the Promoter with the information required to comply with government regulations.

### III Use of QR Codes for Redemption of the Instant Win Component at Automatic Pay Stations for Cash or at Pull-Tab Vending Machines for Credit

An ideal system would utilize the invention to mitigate the problems outlined in the Background section and improve efficiency of the In-Pack Chance promotion.

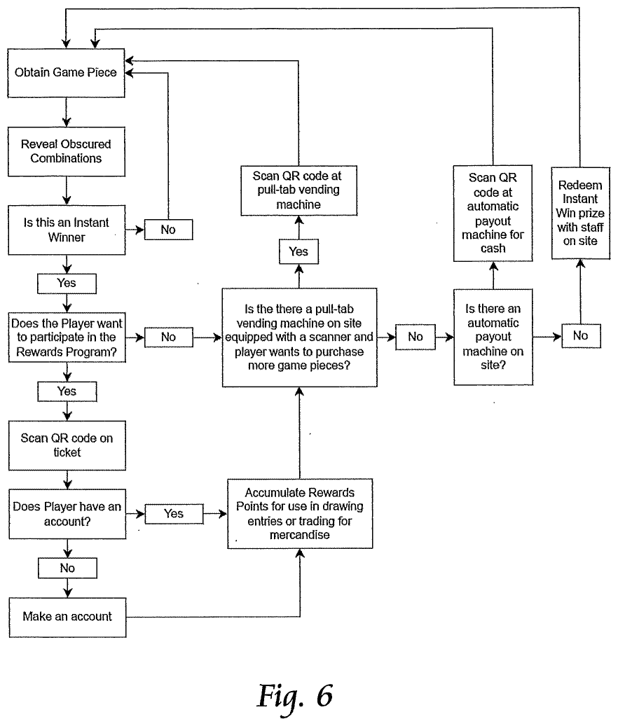

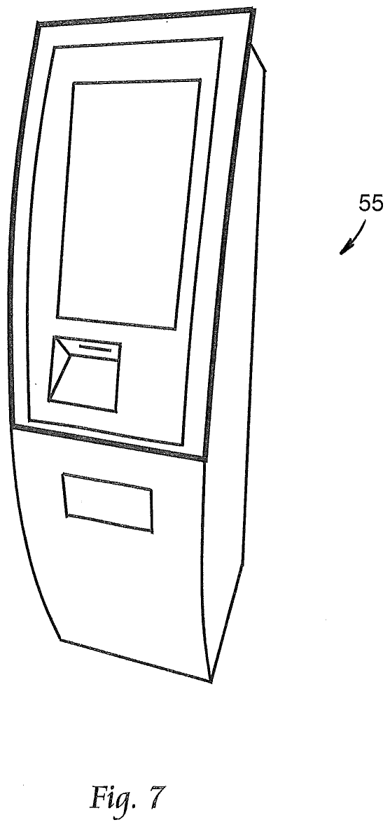

FIG. 6 is a general flow chart of the present invention. The player purchases or otherwise acquires the ticket 10, typically from a dispensing machine as shown in FIG. 5, although it could be directly from a vendor or by procuring one directly from the Promoter. The player then pulls the tabs 18 to reveal the windows 20 to thereby determine if the ticket 10 is an instant winner with a QR Code 26. The player then has a choice if they would like to participate in the Player Rewards program. If they would like to participate, then may scan the QR Code 26 with their smart device. If the player already has an account, the Rewards Points from the winning game piece will be added to their account. If they do not have an account, they will be prompted to create one and then the points will be added to their account. Rewards points may then be redeemed for entries into a grand prize drawing or for merchandise.

The Instant Win portion of the game piece could potentially be redeemed in several ways. Option 1, the winning game piece can be scanned at a pull-tab vending machine scanner 40 to to redeem the Instant Win prize amount as credits on the machine to purchase more game pieces. Option 2, the winning game piece can be scanned at an Automatic Pay Station to redeem the Instant Win prize amount as cash. Option 3, the winning game piece can be redeemed with the on-site staff for the prize amount as cash.

The invention will allow the In-Pack Chance promotion ecosystem described above to mitigate many of the issues that currently exist in Prior Art In-Pack Chance promotions. The QR Code 26 allows for players to redeem any Instant Win game pieces conveniently at an Automatic Pay Station or redemption terminal 55 or at a pull-tab vending machine thereby avoiding human error with on-site staff having to process the winning game pieces. The QR Code 26 also prevents fraud by only allowing tickets that were sold on-site to be redeemed on-site. By scanning the QR code 26, players can also earn rewards points which incentivizes them to submit the information for their winning tickets for compliance with government rules and regulations. Larger reward points amounts can correlate to the larger instant win prizes further encouraging the players to self-report.

### IV. Use of QR Codes for Tracking of the Redemption of the Value Component

A company could work in conjunction with a Promoter to have certain unique identifiers in the QR Code 26 data to offer special discounts, grand prizes, varying levels of coupon 80 (see FIG. 8), etc. If the Value Component of a game piece 10a is based on it being a collectible 90 (see FIG. 9), different levels of value, rarity, or collectability can be encoded in the QR data that players will only discover after the game piece has been revealed and scanned.

For the Value Component, the data in the computer readable code on a game piece could be used to more effectively track the coupon redemption behavior of the player, if the Value Component of the game piece is coupon-based. In the event that the Value Component of the game piece is based on it being collectible, the code could be incorporated as a unique identifier such as a digital collectible or non-fungible token.

The present invention further contemplates alternate systems and methods that utilize the playing pieces of the present invention. If the player does not win instantly as noted above, the system may still utilize the QR code 26 on the game tickets. The player would then scan the QR code 26, as noted above, and either set-up or sign into the player's account, regardless of whether the player had an instant winning ticket. In this situation the QR code 26 is placed on all tickets, winning or losing.

The QR code 26 will then determine how many promotional points the player received from that particular ticket. The points could be determined on either a flat rate, e.g. 10 points earned on each ticket, based on the amount of the instant prize, e.g. $2 won=200 points, $10 won=1000 points, or determined randomly, e.g. each ticket may be between 1 and 1000 points. Those points will then be added to the player's account. The player is able to accumulate points, redeem the points for prizes, or do a combination of these two. The player would then repeat with more tickets, if desired. In this situation, players are encouraged to enter their information for the rewards program in all situations.

The present invention provides several advantages over prior art. For example, because the player can instantly redeem points associated with the promotional portion of the tickets by using the QR code, there is more incentive for the player to accumulate points, as well as providing a higher value to tickets, since the player will be able to consolidate reward points from several tickets. The use of the QR code will also allow players and vendors to comply with any state or federal laws that may be associated with in-pack promotional games as described herein, as they will not have to worry about misplacing a ticket at a later time. Use of the QR code will also limit potential fraud associated with the tickets, as use of the QR code can further verify that a ticket had a particular winning amount.

It is understood that the invention is not limited to the particular construction and arrangement of parts herein illustrated and described, but embraces all such modified forms thereof as come within the scope of the following claims.

I claim:

1. A method for automatically dispensing prizes to a prize winner of a game of chance comprising the steps of:
scanning a game piece having unique computer-readable markings thereon at an automatic pay station when the game piece is presented by the prize winner;
after determining that the unique computer-readable markings correspond to a prize-winning game ticket which is eligible to be redeemed for a prize, and where the value of the prize is above a certain value, enabling the entry of the prize winner's personal information which may be required to be reported to a governmental department, and, after entry of the personal information by the prize winner, directing the prize winner's personal information to the governmental agency or entering it into a database for future reference; and
dispensing the prize in the form of cash from the automatic pay station directly to the prize winner.

2. The method of claim 1 further comprising the steps of:
once the unique computer-readable markings of the game pieces are scanned, determining how many player reward points have been accumulated for the prize winner and adding a number of player reward points corresponding to the unique computer-readable markings on the game piece to an account created for the prize winner.

3. The method of claim 2 wherein the number of rewards points is correlated to the value of the prize to further encourage the prize winner to scan and self-report.

4. The method of claim 2 further comprising recording the player reward points for the prize winner in a data storage device.

5. The method of claim 1 wherein the prize winner self-reports prize winning to governmental departments for compliance with rules and regulations.

6. The method of claim 1 wherein the certain amount is $100.

7. The method of claim 1 further comprising the step of the prize winner scanning the game piece on a phone, tablet, or computer, to thereby determine how many player reward points have been accumulated for the prize winner and adding a number of player reward points corresponding to the unique computer-readable markings on the game piece to an account created for the prize winner.

8. The method of claim 1 further comprising entering the prize winner's personal information into a grand prize drawing.

2. The method of claim 1 further comprising the steps of:
once the unique computer-readable markings of the game pieces are scanned, determining how many player reward points have been accumulated for the prize winner and adding a number of player reward points corresponding to the unique computer-readable markings on the game piece to an account created for the prize winner.

3. The method of claim 2 wherein the number of rewards points is correlated to the value of the prize to further encourage the prize winner to scan and self-report.

4. The method of claim 2 further comprising recording the player reward points for the prize winner in a data storage device.

5. The method of claim 1 wherein the prize winner self-reports prize winning to governmental departments for compliance with rules and regulations.

6. The method of claim 1 wherein the certain amount is $100.

7. The method of claim 1 further comprising the step of the prize winner scanning the game piece on a phone, tablet, or computer, to thereby determine how many player reward points have been accumulated for the prize winner and adding a number of player reward points corresponding to the unique computer-readable markings on the game piece to an account created for the prize winner.

8. The method of claim 1 further comprising entering the prize winner's personal information into a grand prize drawing.
